(19) United States
(12) Patent Application Publication
(10) Pub. No.: US 2026/0275897 A1
(43) Pub. Date: Sep. 17, 2026

(54) CYLINDER HEAD AND EXHAUST MANIFOLD

(71) Applicant: CUMMINS INC., Columbus, IN (US)

(72) Inventors: Adam C. Cecil, Columbus, IN (US); David M. Barnes, Columbus, IN (US); Robert Earl Hoye, Columbus, IN (US); Robert G. Sperry, Columbus, IN (US)

(73) Assignee: CUMMINS INC., Columbus, IN (US)

(21) Appl. No.: 19/469,507

(22) PCT Filed: Mar. 27, 2024
(86) PCT No.: PCT/US2024/021642

§ 371 Date: Sep. 26, 2025

Related U.S. Application Data
(60) Provisional application No. 63/455,043, filed on Mar. 28, 2023.

(51) Int. Cl. F01N 13/10

(52) U.S. Cl. CPC F01N 13/10

(57) ABSTRACT

An internal combustion engine includes a cylinder head with an exhaust manifold (IBM) integrated with the cylinder head. The exhaust manifold comprises a first duct having an interior surface defining a plurality of first duct inlet fluid passages and a first duct exhaust passage in fluid receiving communication with the plurality of first duct inlet fluid passages. The exhaust manifold further comprises a fin projecting from the interior surface into one of the first duct inlet fluid passages.

### CROSS-REFERENCE TO RELATED PATENT APPLICATION

This application claims the benefit of and priority to U.S. Provisional Patent Application 63/455,043, filed on Mar. 28, 2023, the contents of which are incorporated herein by reference in their entirety.

### TECHNICAL FIELD

The present application relates generally to exhaust manifolds and cylinder heads of internal combustion engines having the exhaust manifold.

### BACKGROUND

An internal combustion engine may include a cylinder head and an exhaust manifold. The cylinder head may also include a cooling system within the cylinder head and a turbocharger coupled to the cylinder head. Gases are fed through the integrated exhaust manifold from the cylinder head, into and through the turbocharger, and then through the exhaust aftertreatment system. By integrating the exhaust manifold assembly with the cylinder head, more exhaust gas energy can be rejected to the cooling system, thereby reducing turbocharger turbine inlet temperatures.

### SUMMARY

In one set of embodiments, a cylinder head comprises a cylinder head body and an exhaust manifold integrated within the cylinder head body. The exhaust manifold comprises a first duct including a plurality of first duct inlet fluid passages and a first duct exhaust passage in fluid receiving communication with the plurality of first duct inlet fluid passages. Each of the plurality of first duct inlet fluid passages define a channel in the interior thereof. One of the first duct inlet fluid passages includes a fin projecting within the channel.

In another set of embodiments, an exhaust manifold assembly for integration with a cylinder head comprises a first duct. The first duct has a first interior surface defining a plurality of first duct inlet fluid passages. One or more first fins project from the first interior surface into one or more of the first duct inlet fluid passages. The exhaust manifold assembly also comprises a second duct having a second interior surface defining a plurality of second duct inlet fluid passages. One or more second fins project from the second interior surface into one or more of the second duct inlet fluid passages.

### BRIEF DESCRIPTION OF THE DRAWINGS

The details of one or more implementations are set forth in the accompanying drawing and the description below. Other features, aspects, and advantages of the disclosure will become apparent from the description, the drawing, and the claims, in which:

FIG. 1 is a perspective view of an example internal combustion engine system;

FIG. 2 is a perspective view of the cylinder head of the internal combustion engine system of FIG. 1;

FIG. 3 is a perspective view of a portion of the cylinder head of FIG. 2;

FIG. 4 is a cross-sectional view of a portion of the cylinder head of FIG. 2 taken along line A-A thereof;

FIG. 5 is a perspective view of an exhaust manifold integrated in the cylinder head of FIG. 2;

FIG. 6 shows a first example cross-section for the exhaust manifold of FIG. 5, taken along line B-B thereof;

FIG. 7 shows a second example cross-section for the exhaust manifold of FIG. 5, taken along line B-B thereof,

FIG. 8 shows a third example cross-section for the exhaust manifold of FIG. 5, taken along line B-B thereof; and

FIG. 9 shows a fourth example cross-section for the exhaust manifold of FIG. 5, taken along line B-B thereof.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION OF VARIOUS EMBODIMENTS

Following below are more detailed descriptions of various concepts related to, and implementations of, apparatuses and systems for cooling exhaust within exhaust manifold assemblies for cylinder heads of internal combustion engines. The various concepts introduced above and discussed in greater detail below may be implemented in any of a number of ways, as the described concepts are not limited to any particular manner of implementation. Examples of specific implementations and applications are provided primarily for illustrative purposes. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

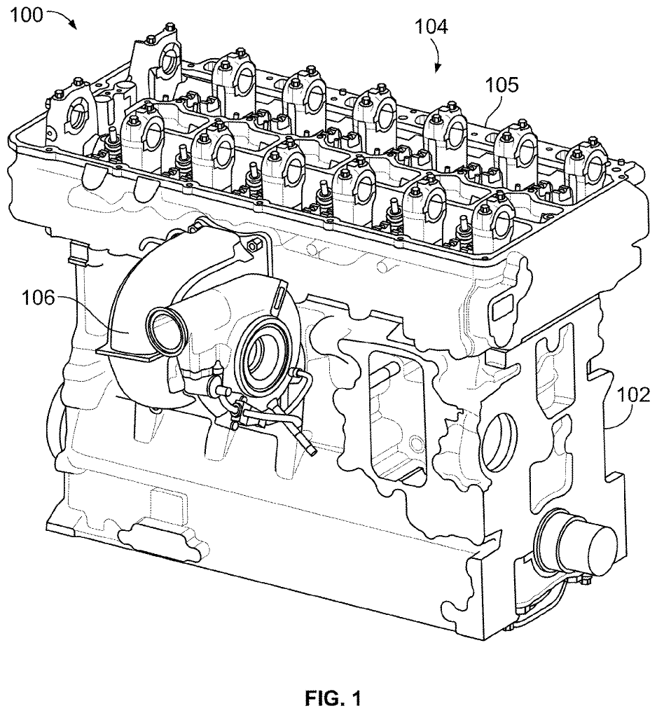

As shown in FIGS. 1-9, a cylinder head 104 comprises a cylinder head body 105 and an exhaust manifold 500 (e.g., an outlet manifold, an exhaust manifold assembly, etc.) integrated within the cylinder head body 105. The exhaust manifold 500 comprises a first duct 502 including a plurality of first duct inlet fluid passages 508a-508c and a first duct exhaust passage 506 in fluid receiving communication with the plurality of first duct inlet fluid passages 508a-508c. Each of the plurality of first duct inlet fluid passages 508a-508c define a channel in the interior thereof. One of the first duct inlet fluid passages 508a-508c includes a fin 510 projecting within the channel.

As further shown n FIGS. 1-9, the exhaust manifold 500 (e.g., an outlet manifold, an exhaust manifold assembly, etc.) for integration with the cylinder head 104 comprises the first duct 502. The first duct 502 has a first interior surface 514 defining the plurality of first duct inlet fluid passages 508a-508c. One or more of the fins 510 project from the first interior surface 514 into one or more of the first duct inlet fluid passages 508a-508c. The exhaust manifold 500 also comprises a second duct 504 having a second interior surface 516 defining a plurality of second duct inlet fluid passages 512a-512c. One or more second fins project from the second interior surface 516 into one or more of the second duct inlet fluid passages 512a-512c.

FIG. 1 depicts an example internal combustion engine system 100. The internal combustion engine system 100 may be, for example, a diesel internal combustion engine system, a gasoline internal combustion engine system, a hybrid internal combustion engine system, etc. The internal combustion engine system 100 is configured to combust a fuel (e.g., diesel fuel, gasoline, etc.) to produce energy that may be utilized by various outputs. For example, the internal combustion engine system 100 may produce energy that is utilized to drive a movement member (e.g., wheel, tread, propeller, impeller, turbine, rotor, etc.) or power a generator.

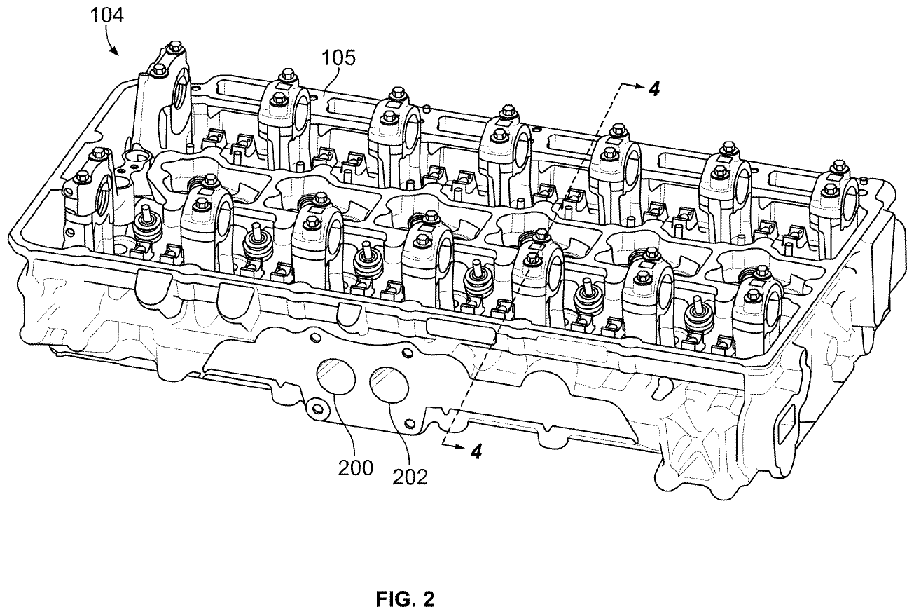

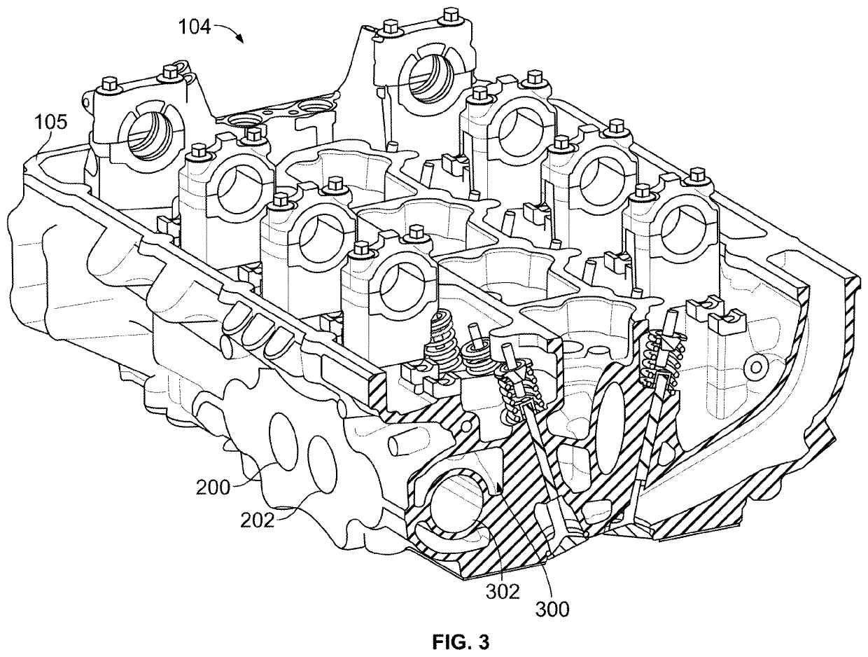

The internal combustion engine system 100 includes a cylinder block 102 and the cylinder head 104. The cylinder block 102 houses the engine cylinders for the internal combustion engine 100. The cylinder head 104 is coupled to the cylinder block 102. FIG. 2 is a perspective view of the cylinder head 104. FIG. 3 is a perspective view of a portion of the cylinder head 104.

The internal combustion engine system 100 also includes a plurality of engine cylinders (not shown). The number of engine cylinders may vary depending upon the particular engine arrangement (e.g., two engine cylinders, four engine cylinders, five engine cylinders, six engine cylinders, seven engine cylinders, eight engine cylinders, nine engine cylinders, ten engine cylinders, twelve engine cylinders, fourteen engine cylinders, etc.).

The internal combustion engine system 100 depicted in FIG. 1 also includes a turbocharger 106. The turbocharger 106 is coupled to the cylinder head 104 and receives exhaust gas from the cylinder head 104. As shown in FIG. 2, the cylinder head 104 includes a first outlet 200 and a second outlet 202. The exhaust gas exits the cylinder head 104 at the first outlet 200 and the second outlet 200 and enters the turbocharger 106.

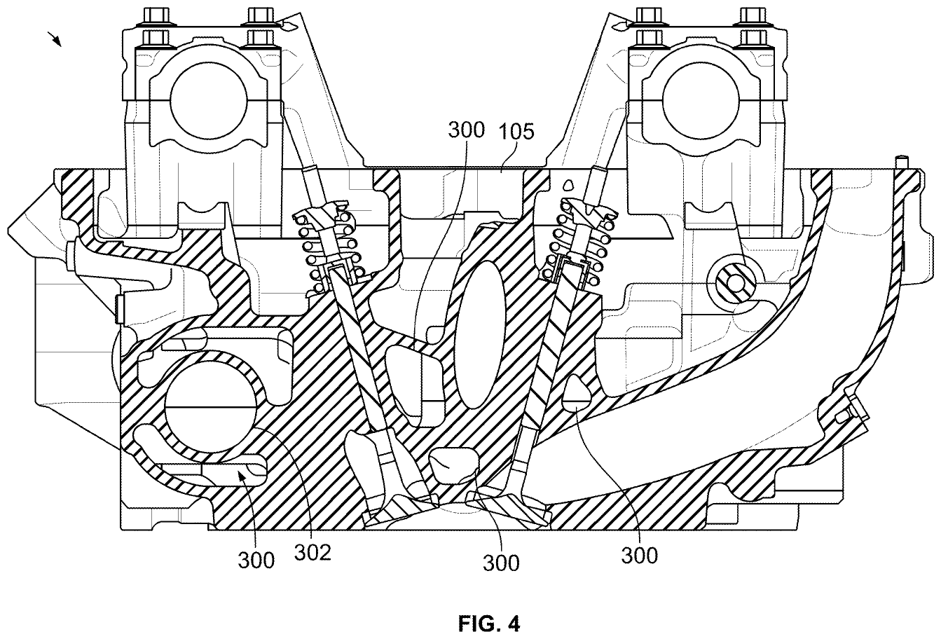

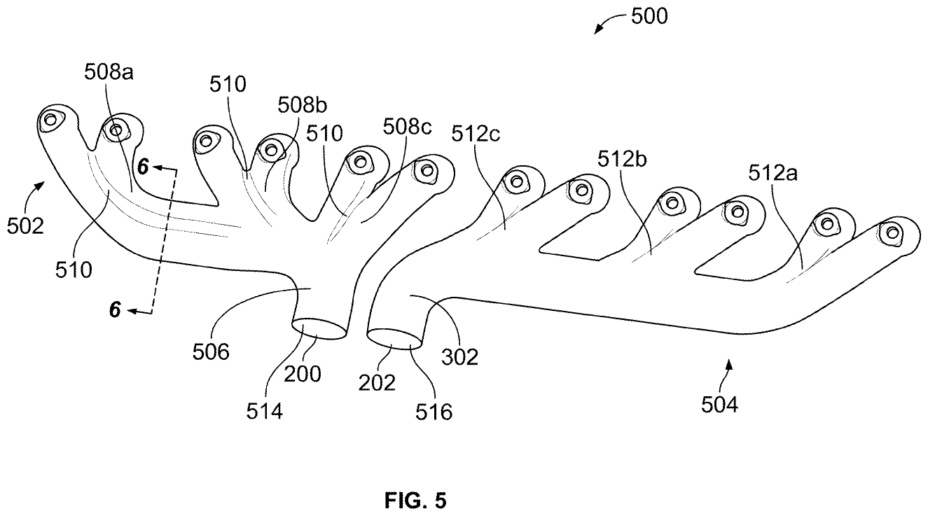

The internal combustion engine system 100 also includes the exhaust manifold 500 (e.g., an outlet manifold, an exhaust manifold assembly, etc.) (shown in FIG. 5) for integration with the cylinder head 104. The exhaust manifold 500, portions of which are additionally shown in FIGS. 3-4, is coupled to a second side (e.g., hot side, exhaust side, etc.) of the cylinder head 104 and is configured to receive exhaust gas from the cylinder head 104.

The exhaust manifold 500 is configured to receive the exhaust gas from each of the engine cylinders of the internal combustion engine system 100. In some embodiments, the exhaust manifold 500 is coupled to an outlet exhaust gas conduit (not shown) and configured to provide the exhaust gas to the outlet exhaust gas conduit. The outlet exhaust gas conduit may provide the exhaust gas to an aftertreatment system (e.g., a system that doses the exhaust gas with reductant and provides the exhaust gas through a catalyst member, etc.). In the internal combustion engine system 100 of FIG. 1, exhaust gas is provided from the exhaust manifold 500 to the turbocharger 106 and from the turbocharger 106 to the outlet exhaust gas conduit.

As shown in FIGS. 3 and 4, the cylinder head 104 additionally includes a cooling system 300. The cooling system 300 cools the exhaust gas flowing through the exhaust manifold 500. The cooling system 300 may be comprise a cooling fluid such as water or other coolant. The cooling fluid may surround any passage carrying exhaust gas and provide cooling to the exhaust gas. The cooling system 300 may be located in any area or position within the cylinder head 104.

FIGS. 3-5 additionally depict a second duct exhaust passage 302. In the embodiment of FIGS. 3-5, the second duct exhaust passage 302 conveys the exhaust gas from the second duct inlet fluid passages 512a-512c to the second outlet 202, where the exhaust gas exits the second duct 504 of the exhaust manifold 500 and passes into the turbocharger 106.

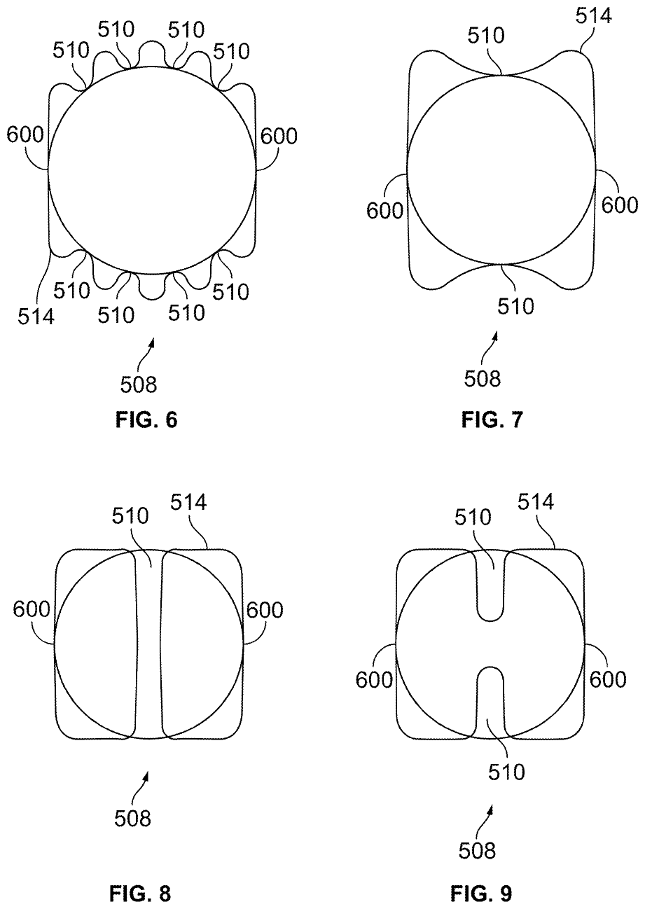

Turning now to FIGS. 5-9, the exhaust manifold 500 for integration with the cylinder head 104 comprises the first duct 502 having the interior surface defining the plurality of first duct inlet fluid passages 508a-508c and the first duct exhaust passage 506 in fluid receiving communication with the plurality of first duct inlet fluid passages 508a-508c. The fin 510, different examples of which are shown in FIGS. 6-9 and described further below, projects from the interior surface into one of the first duct inlet fluid passages 508a-508c. In particular embodiments, the interior surface includes two fins 510 projecting into the one of the first duct inlet fluid passages 508a-508c. In the same or other embodiments, the one of the first duct inlet fluid passages 508a-508c has a non-circular cross-section along a plane that intersects the fin 510. In particular embodiments, one of the plurality of first duct inlet fluid passages 508a-508c is defined in part by a first side surface 600 and a second side surface 600, the first side surface 600 substantially parallel to the second side surface 600 and the fin 510. The fin 510 may have an axial length toward a center of the at least one of the first duct inlet fluid passages 508a-508c greater than a width of the fin 510. In various embodiments, the fin 510 has a width greater than an axial length of the fin 510 toward a center of the one of the first duct inlet fluid passages 508a-508c. In particular arrangements, the fin 510 bisects the one of the first duct inlet fluid passages, 508a-508c the fin 510 creating an area of two channels for fluid passage separated by the fin 510 within the one of the first duct fluid passages 508a-508c. In particular embodiments, separate of the fins 510 project from the interior surface into separate ones of the first duct inlet fluid passages 508a-508c.

FIG. 5 is a perspective view of the exhaust manifold 500 integrated in the cylinder head 104 of FIG. 2. The exhaust manifold 500 includes the first duct 502 and the second duct 504. In the embodiment of FIG. 5, the first duct 502 collects exhaust gas from one subset of the engine cylinders, and the second duct 504 collects exhaust gas from another subset of the engine cylinders.

The first duct 502 includes the interior surface defining the first outlet 200, the first duct exhaust passage 506, and the first duct inlet fluid passages 508a-508c. The first duct inlet fluid passages 508a-508c receive fluid (e.g., exhaust gas, etc.) from the cylinder head 104. The first duct exhaust passage 506 conveys the exhaust gas from the first duct inlet fluid passages 508a-508c to the first outlet 200, where the exhaust gas exits the first duct 502 of the exhaust manifold 500 and passes into the turbocharger 106.

The second duct 504 includes the interior surface defining the second outlet 202, the second duct exhaust passage 302, and the second duct inlet fluid passages 512a-512c. The second duct inlet fluid passages 512a-512c receive fluid (e.g., exhaust gas, etc.) from the cylinder head 104. The second duct exhaust passage 302 conveys the exhaust gas from the second duct inlet fluid passages 512a-512c to the second outlet 202, where the exhaust gas exits the second duct 504 of the exhaust manifold 500 and passes into the turbocharger 106.

The first duct exhaust passage 506 may have various cross-sectional shapes. In various embodiments, the first duct exhaust passage 506 has a non-circular cross-section. However, in other embodiments, the first duct exhaust passage 506 is elliptical, circular, oval, triangular, square, rectangular, hexagonal, pentagonal, or otherwise similarly shaped.

The second duct exhaust passage 302 may also have various cross-sectional shapes. In various embodiments, the second duct exhaust passage 302 has a non-circular cross-section. However, in other embodiments, the second duct exhaust passage 302 is elliptical, circular, oval, triangular, square, rectangular, hexagonal, pentagonal, or otherwise similarly shaped.

The first duct inlet fluid passages 508a-508c defined by the interior surface of the exhaust manifold 500 each define a channel therein and include one or more of the fins 510. Each of the fins 510 is positioned within a respective one of the first duct inlet fluid passages 508a-508c such that the respective fin 510 protrudes from the interior surface of the respective one of the first duct inlet fluid passages 508a-508c. Each of the fins 510 protrudes into the respective channel defined by the respective one of the first duct inlet fluid passages 508a-508c and extends toward the center of the channel defined by the respective one of the first duct inlet fluid passages 508a-508c.

In the embodiment of FIG. 5, one or more of the fins 510 protrude into each of the first duct inlet fluid passages 508a-508c. However, in other embodiments, no fins 510 may protrude into one or more of the first duct inlet fluid passages 508a-508c.

Each of the fins 510 are configured to change the geometry of one or more of the first duct inlet fluid passages 508a-508c. In particular, each of the fins 510 increases the surface area of the inner surface of the one or more first duct inlet fluid passages 508a-508c. By increasing the surface area of the interior surface defining the one or more first duct inlet fluid passages 508a-508c, the surface area of the interior surface defining the one or more first duct inlet fluid passages 508a-508c is subjected to a greater amount of cooling from the cooling system 300 (shown in FIGS. 3 and 4). A greater surface area of the first duct inlet fluid passages 508a-508c subjected to cooling from the cooling system 300 results in more energy rejection from the exhaust gas conveyed through the first duct inlet fluid passages 508a-508c. As a result, the exhaust gas may undergo an increased temperature reduction and may therefore enter the turbocharger 106 at a lower temperature. In some embodiments, the second duct inlet fluid passages 512a-512c may also include one or more of the fins 510.

FIGS. 6-9 depict various example cross-sections for the first duct inlet fluid passages 508 including one or more of the fins 510. A circular reference shape for the first duct inlet fluid passage 508 is depicted in each Figure for reference. Each of the fins 510 is positioned within the first duct inlet fluid passage 508 such that the respective fin 510 protrudes from the interior surface of the first duct 502 into the channel defined by the first duct inlet fluid passage 508. Each of the fins 510 protrudes into the channel defined by the first duct inlet fluid passage 508 and extends toward the center of the channel defined by the first duct inlet fluid passage 508.

In FIG. 6, the fins 510 are structured as a series of ridges along the circumference of the interior surface defining the first duct inlet fluid passage 508. Each of the fins 510 is positioned within the first duct inlet fluid passage 508 such that the respective fin 510 protrudes from the interior surface into the channel defined by the first duct inlet fluid passage 508. Each of the fins 510 protrudes into the channel and extends toward the center of the channel defined by the first duct inlet fluid passage 508.

In the embodiment of FIG. 6, the fins 510 are rounded. In other embodiments, the fins 510 may be pointed, squared, oval-shaped, or possess still other shapes.

Also in the embodiment of FIG. 6, the width of each of the fins 510 is equal to or approximately equal to the depth of each of the fins 510. In other embodiments, the depth of each of the fins 510 may be greater than or less than the width of each of the fins 510. In still other embodiments, the first duct inlet fluid passage 508 may contain a plurality of the fins 510 having a multitude of fin geometries such that one or more of the fins 510 have a greater width than depth, and one or more of the fins 510 have a greater depth than width.

In the embodiment of FIG. 6, the first duct inlet fluid passage 508 is defined by side surfaces 600 between each series of the fins 510. The side surfaces 600 may be substantially flat or straight and may oppose each other and be positioned parallel or substantially parallel to one another. In some embodiments, the side surfaces 600 may be tapered, rounded, ridged, pointed, squared, oval-shaped, or possess still other shapes.

Additionally, in the embodiment of FIG. 6, there are four of the fins 510 protruding from a top portion of the defined first duct inlet fluid passage 508 and four of the fins 510 protruding from a bottom portion of the defined first duct inlet fluid passage 508. In other embodiments, the first duct inlet fluid passage 508 may contain more or less than four of the fins 510 protruding from a first or top portion of the defined first duct inlet fluid passage 508 and more or less than four of the fins 510 protruding from a second or bottom portion of the defined first duct inlet fluid passage 508.

In other embodiments, the fins 510 may continue around the entire geometry of the first duct inlet fluid passage 508. For example, the first duct inlet fluid passage 508 may appear to have a plurality of the fins 510 connected to one another and positioned to form a circular or substantially circular cross-section. In another example a plurality of the fins 510 are adjacent to one another and positioned to form a cross-section having an elliptical, circular, oval, triangular, square, rectangular, hexagonal, pentagonal, or otherwise similar shape. In such examples, the first duct inlet fluid passage may not be defined by any side surfaces 600, or the area of the side surfaces 600 may be greatly reduced.

In yet another set of embodiments, the first duct inlet fluid passage 508 may have one of the fins 510 having a ridged, circular, rounded, pointed, squared, or oval shape, or possessing still other shapes.

As shown in FIG. 7, each of the fins 510 is structured as a protrusion from the interior surface defining the first duct inlet fluid passage 508. Each of the fins 510 is positioned within the first duct inlet fluid passage 508 such that the respective fin 510 protrudes from the internal surface defining the first duct inlet fluid passage 508 into the channel. Each of the fins 510 protrudes into the channel and extends toward the center of the channel defined by the first duct inlet fluid passage 508.

In the embodiment of FIG. 7, each fin 510 is rounded. In other embodiments, each of the fins 510 may be ridged, pointed, squared, oval-shaped, or possess still other shapes.

Also in the embodiment of FIG. 7, the width of each of the fins 510 is greater than the depth of each of the fins 510. In other embodiments, the depth of each of the fins 510 may be greater than the width of each of the fins 510. In other embodiments, the first duct inlet fluid passage 508 may contain a plurality of the fins 510 having a multitude of fin geometries such that one or more of the fins 510 have a greater width than depth, and one or more of the fins 510 have a greater depth than width.

In the embodiment of FIG. 7, the first duct inlet fluid passage 508 is defined in part by the side surfaces 600 between each fin 510. The side surfaces 600 may be substantially flat or straight and may oppose each other and be positioned parallel or substantially parallel to one another. In some embodiments, the side surfaces 600 may be tapered, rounded, ridged, pointed, squared, oval-shaped, or possess still other shapes.

In the embodiment of FIG. 7, the protruding end of each of the fins 510 is oriented toward a central axis. In other embodiments, the protruding end of each of the fins 510 may be oriented toward a different axis.

Additionally, in the embodiment of FIG. 7, there is one fin 510 protruding from a top portion of the defined the first duct inlet fluid passage 508 and one fin 510 protruding from a bottom portion of the defined first duct inlet fluid passage 508. In other embodiments, the first duct inlet fluid passage 508 may contain more or less than one of the fins 510 protruding from a first or top portion of the defined first duct inlet fluid passage 508 and more or less than one of the fins 510 protruding from a second or bottom portion of the defined first duct inlet fluid passage 508.

In some embodiments, the fins 510 may continue around the entire geometry of the defined first duct inlet fluid passage 508. For example, the defined first duct inlet fluid passage 508 may appear to have a plurality of the fins 510 connected to one another and positioned to form a circular or substantially circular cross-section. In another example, the defined first duct inlet fluid passage 508 may appear to have a plurality of the fins 510 adjacent to one another and positioned to form a cross-section having an elliptical, circular, oval, triangular, square, rectangular, hexagonal, pentagonal, or otherwise similar shape. In such examples, the first duct inlet fluid passage may not contain any of the side surfaces 600 or the area of the side surfaces 600 may be greatly reduced.

In yet another set of embodiments, the defined first duct inlet fluid passage 508 may have one fin 510 having a ridged, circular, rounded, pointed, squared, or oval shape, or possess still other shapes.

As shown in FIG. 8, the fin 510 is structured as a rib running through the defined first duct inlet fluid passage 508. The fin 510 is positioned within the first duct inlet fluid passage 508 such that the fin 510 protrudes from the interior surface at a top portion of the defined first duct inlet fluid passage 508 into the channel defined by the first duct inlet fluid passage 508 and extends to the interior surface at the bottom portion of the defined first duct inlet fluid passage 508.

In the embodiment of FIG. 8, the fin 510 is substantially straight. In other embodiments, the fin 510 may be tapered, rounded, ridged, pointed, squared, oval-shaped, or possess still other shapes.

In the embodiment of FIG. 8, the depth of the fin 510 is greater than the width of the fin 510. In other embodiments, the width of the fin 510 may be greater than the depth of the fin 510.

In the embodiment of FIG. 8, the first duct inlet fluid passage 508 has the side surfaces 600 between each side of the fin 510. The side surfaces 600 may be substantially flat or straight and may oppose each other and be positioned parallel or substantially parallel to one another. In some embodiments, the side surfaces 600 may be tapered, rounded, ridged, pointed, squared, oval-shaped, or possess still other shapes.

In the embodiment of FIG. 8, there is one fin 510 protruding from a first portion of the defined first duct inlet fluid passage 508 and continuing through the channel defined by the first duct inlet fluid passage 508 to a portion of the defined first duct inlet fluid passage 508 such that the fin 510 creates an area of two channels separated by the fin 510.

In other embodiments, more than one of the fins 510 may protrude into the channel defined by the first duct inlet fluid passage 508. For example, more than one of the fins 510 may protrude into the channel defined by the first duct inlet fluid passage 508 such that the fins 510 create more than two channel areas. In another example, more than one fin 510 may protrude into the channel defined by the first duct inlet fluid passage 508 such that one or more of the fins 510 intersect each other. The channel areas may be of equal, substantially equal, or varied area. Each channel area may be in communication or not in communication with each other channel area. Each of the fins 510 may be substantially straight, straight, tapered, rounded, ridged, pointed, squared, oval-shaped, or possess still other shapes.

In the embodiment of FIG. 8, the fin 510 bisects the channel defined by the first duct inlet fluid passage 508. For example, the channel defined by the first duct inlet fluid passage 508 is bisected by the fin 510 such that the channel defined by the first duct inlet fluid passage 508 is divided into two channels having two equal or substantially equal areas. However, the fin 510 does not need to bisect that first duct inlet fluid passage, and the fin 510 could extend from the interior surface at a first location to another location of the interior surface not opposite the first location. In other embodiments, more than one of the fins 510 may bisect the channel defined by the first duct inlet fluid passage 508, such that one or more of the fins 510 intersect each other. For example, one fin 510 may bisect the channel defined by the first duct inlet fluid passage 508 in a north-south orientation, and one fin 510 may bisect the channel defined by the first duct inlet fluid passage 508 in an east-west orientation. The channel areas may be of equal, substantially equal, or varied areas. Each channel area may be in communication or not in communication with each other channel area. Each of the fins 510 may be substantially straight, straight, tapered, rounded, ridged, pointed, squared, oval-shaped, or possess still other shapes.

As shown in FIG. 9, the fins 510 are structured as two ribs. Each of the fins 510 is positioned within the first duct inlet fluid passage 508 such that the respective fin 510 protrudes from the interior surface defining the first duct inlet fluid passage 508 into the channel defined by the first duct inlet fluid passage 508. Each of the fins 510 protrudes into the channel defined by the first duct inlet fluid passage 508 and extends toward the center of the channel defined by the first duct inlet fluid passage 508.

In the embodiment of FIG. 9, each of the fins 510 is substantially straight. In other embodiments, the fin 510 may be tapered, rounded, ridged, pointed, squared, oval-shaped, or possess still other shapes.

In the embodiment of FIG. 9, the depth of each of the fins 510 is greater than the width of each of the fins 510. In other embodiments, the width of each of the fins 510 may be greater than the depth of each of the fins 510. In other embodiments, the first duct inlet fluid passage 508 may contain a plurality of the fins 510 having a multitude of fin geometries such that one or more of the fins 510 have a greater width than depth, and one or more of the fins 510 have a greater depth than width.

In the embodiment of FIG. 9, the first duct inlet fluid passage 508 has the side surfaces 600 between each of the fins 510. The side surfaces 600 may be substantially flat or straight and may oppose each other and be positioned parallel or substantially parallel to one another. In some embodiments, the side surfaces 600 may be tapered, rounded, ridged, pointed, squared, oval-shaped, or possess still other shapes.

In the embodiment of FIG. 9, there is one fin 510 protruding from the interior surface a top portion of the defined first duct inlet fluid passage 508 and one fin 510 protruding from the interior surface at a bottom portion of the defined first duct inlet fluid passage 508. In other embodiments, the first duct inlet fluid passage 508 may contain more or less than one of the fins 510 protruding from the interior surface at a first or top portion of the defined first duct inlet fluid passage 508 and more or less than one of the fins 510 protruding from the interior surface at a second or bottom portion of the defined first duct inlet fluid passage 508.

In some embodiments, the fins 510 may continue around the entire geometry of the first duct inlet fluid passage 508. For example, the first duct inlet fluid passage 508 may appear to have a plurality of the fins 510 adjacent to one another and positioned to form a circular or substantially circular cross-section. In another example, the first duct inlet fluid passage 508 may appear to have a plurality of the fins 510 adjacent to one another and positioned to form a cross-section having an elliptical, circular, oval, triangular, square, rectangular, hexagonal, pentagonal, or otherwise similar shape. In such examples, the first duct inlet fluid passage may not contain any of the side surfaces 600 or the area of the side surfaces 600 may be greatly reduced.

In yet another set of embodiments, the first duct inlet fluid passage 508 may have one fin 510 having a ridged, circular, rounded, pointed, squared, or oval shape, or possess still other shapes.

In the embodiment of FIG. 9, the protruding end of each of the fins 510 is oriented toward a central axis and the fins 510 substantially bisect the channel defined by the first duct inlet fluid passage 508. In other embodiments, one or more of the fins 510 may protrude from the first duct inlet fluid passage 508 such that each of the fins 510 substantially divides the channel defined by the first duct inlet fluid passage 508. In the same or other embodiments, the protruding end of each of the fins 510 may be oriented toward the same or a different axis. In some embodiments, more than one of the fins 510 may divide or bisect the channel defined by the first duct inlet fluid passage 508, such that the fins 510 intersect each other. The fins 510 may be substantially straight, straight, tapered, rounded, ridged, pointed, squared, oval-shaped, or possess still other shapes.

In some embodiments, the first duct exhaust passage 506 and the second duct exhaust passage 302 are the furthest downstream portion of the exhaust manifold 500. The first duct inlet fluid passages 508a-c may converge into the first duct exhaust passage 506 and the second duct inlet fluid passages 512a-c may converge into the second duct exhaust passage 302. The one or more fins 510 may create the area of the two channels for fluid passage within the first duct inlet fluid passages 508a-c or the second duct inlet fluid passages 512a-c upstream of the point where the first duct inlet fluid passages 508a-c converge into the first duct exhaust passage 506 and the second duct inlet fluid passages 512a-c converge into the second duct exhaust passage 302. The portion of the exhaust manifold 500 that contains the areas of the two channels for fluid passage may be the furthest upstream portion of the exhaust manifold 500.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “approximately,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. An exhaust manifold for integration with a cylinder head, the exhaust manifold comprising:
a first duct having an interior surface defining a plurality of first duct inlet fluid passages and a first duct exhaust passage in fluid receiving communication with the plurality of first duct inlet fluid passages,
a fin projecting from the interior surface into one of the first duct inlet fluid passages.

2. The exhaust manifold of claim 1, wherein the interior surface includes two fins projecting into the one of the first duct inlet fluid passages.

3. The exhaust manifold of claim 1, wherein the one of the first duct inlet fluid passages has a non-circular cross-section along a plane that intersects the fin.

4. The exhaust manifold of claim 1, wherein the one of the plurality of first duct inlet fluid passages is defined in part by a first side surface and a second side surface, the first side surface substantially parallel to the second side surface and the fin.

5. The exhaust manifold of claim 1, wherein the fin has an axial length toward a center of the at least one of the first duct inlet fluid passage greater than a width of the fin.

6. The exhaust manifold of claim 1, wherein the fin has a width greater than an axial length of the fin toward a center of the one of the first duct inlet fluid passages.

7. The exhaust manifold of claim 1, wherein the fin bisects the one of the first duct inlet fluid passages, the fin creating an area of two channels for fluid passage separated by the fin within the one of the first duct fluid passages.

8. The exhaust manifold of claim 1, wherein separate fins project from the interior surface into separate ones of the first duct inlet fluid passages.

9. A cylinder head comprising:
a cylinder head body; and
an exhaust manifold of claim 1 integrated with the cylinder head body.

10. An exhaust manifold assembly for integration with a cylinder head, the exhaust manifold assembly comprising:
a first duct having a first interior surface defining a plurality of first duct inlet fluid passages;
one or more first fins projecting from the first interior surface into one or more of the first duct inlet fluid passages;
a second duct having a second interior surface defining a plurality of second duct inlet fluid passages; and
one or more second fins projecting from the second interior surface into one or more of the second duct inlet fluid passages.

11. The exhaust manifold assembly of claim 10, wherein at least one of the plurality of first duct inlet fluid passages includes two of the first fins or at least one of the second duct inlet fluid passages includes two of the second fins.

12. The exhaust manifold assembly of claim 10, wherein at least one of the plurality of first duct inlet fluid passages has a non-circular cross-section along a plane that intersects one of the first fins or at least one of the plurality of second duct inlet fluid passages has a non-circular cross-section along a plane that intersects one of the second fins.

13. The exhaust manifold assembly of claim 10, wherein at least one of:
an axial length of at least one of the first fins measured toward a center of one of the plurality of first duct inlet fluid passages is greater than a width of the at least one of the first fins; and
the width of the at least one of the first fins measured toward a center of one of the plurality of first duct inlet fluid passages is greater than the axial length of the at least one of the first fins.

14. The exhaust manifold assembly of claim 10, wherein at least one of:
an axial length of at least one of the second fins measured toward a center of one of the plurality of second duct inlet fluid passages is greater than a width of the at least one of the second fins; and
the width of the at least one of the second fins measured toward a center of one of the plurality of second duct inlet fluid passages is greater than the axial length of the at least one of the second fins.

15. The exhaust manifold assembly of claim 10, wherein the one or more first fins bisect one or more of the first duct inlet fluid passages.

16. The exhaust manifold assembly of claim 10, wherein the one or more second fins bisect one or more of the second duct inlet fluid passages.

17. The exhaust manifold assembly of claim 10, wherein the plurality of first duct inlet fluid passages converge at an area downstream of the one or more first fins into a first duct exhaust passage in fluid receiving communication with the plurality of first duct inlet fluid passages.

18. The exhaust manifold assembly of claim 10, wherein the plurality of second duct inlet fluid passages converge at an area downstream of the one or more second fins into a second duct exhaust passage in fluid receiving communication with the plurality of second duct inlet fluid passages.

19. The exhaust manifold assembly of claim 10, wherein the one or more first fins create an area of two channels for fluid passage within one or more of the plurality of first duct inlet fluid passages.

20. The exhaust manifold assembly of claim 10, wherein the one or more second fins create an area of two channels for fluid passage within one or more of the plurality of second duct inlet fluid passages.

21. A cylinder head comprising:
a cylinder head body; and
the exhaust manifold of claim 1 integrated with the cylinder head body.
